(19) United States
(12) Patent Application Publication
(10) Pub. No.: US 2025/0239076 A1
(43) Pub. Date: Jul. 24, 2025

(54) PREDICTION OF NBA TALENT AND QUALITY FROM NON-PROFESSIONAL TRACKING DATA

(71) Applicant: STATS LLC, Chicago, IL (US)

(72) Inventors: Andrew Patton, Chicago, IL (US); Nathan Walker, Durham, NC (US); Alex Ottenwess, Chicago, IL (US); Matthew Scott, Chicago, IL (US)

(73) Assignee: STATS LLC, Chicago, IL (US)

(21) Appl. No.: 19/175,194

(22) Filed: Apr. 10, 2025

Related U.S. Application Data
(63) Continuation of application No. 18/336,400, filed on Jun. 16, 2023, now Pat. No. 12,307,767.
Application No. 18/336,400 is a continuation of application No. 17/449,694, filed on Oct. 1, 2021, now Pat. No. 11,682,209.
(60) Provisional application No. 63/086,372, filed on Oct. 1, 2020.

(51) Int. Cl. G06V 20/40; G06N 5/04; G06T 7/292

(52) U.S. Cl. CPC G06V 20/42; G06N 5/042; G06T 7/292; G06V 20/44

(57) ABSTRACT

A computing system identifies broadcast video for a plurality of games in a first league. The broadcast video includes a plurality of video frames. The computing system generates tracking data for each game from the broadcast video of a corresponding game. The computing system enriches the tracking data. The enriching includes merging play-by-play data for the game with the tracking data of the corresponding game. The computing system generates padded tracking data based on the tracking data. The computing system projects player performance in a second league for each player based on the tracking data and the padded tracking data.

### CROSS-REFERENCE TO RELATED APPLICATIONS

This application is a continuation of, and claims the benefit of priority to, U.S. patent application Ser. No. 18/336,400, filed on Jun. 16, 2023, which is a continuation of, and claims the benefit of priority to, U.S. patent application Ser. No. 17/449,694, filed on Oct. 1, 2021, which claims priority to U.S. Provisional Application No. 63/086,372, filed on Oct. 1, 2020, which are hereby incorporated by reference in their entireties.

### FIELD OF DISCLOSURE

This application generally relates to a system and method for predicting NBA talent from non-professional tracking data.

### BACKGROUND

Professional sports commentators and fans alike typically engage in what-if scenarios for players. For example, a common thread in sports media focuses on how a college player or international player may translate to a professional league (e.g., the NBA).

### SUMMARY

In some embodiments, a method is disclosed herein. A computing system identifies broadcast video for a plurality of games in a first league. The broadcast video includes a plurality of video frames. The computing system generates tracking data for each game from the broadcast video of a corresponding game. The computing system enriches the tracking data. The enriching includes merging play-by-play data for the game with the tracking data of the corresponding game. The computing system generates padded tracking data based on the tracking data. The computing system projects player performance in a second league for each player based on the tracking data and the padded tracking data.

In some embodiments, a non-transitory computer readable medium is disclosed herein. The non-transitory computer readable medium includes one or more sequence of instructions, which, when executed by a processor, causes a computing system to perform operations. The operations include identifying, by a computing system, broadcast video for a plurality of games. The broadcast video includes a plurality of video frames. The operations further include generating, by the computing system, tracking data for each game from the broadcast video of a corresponding game. The operations further include enriching, by the computing system, the tracking data. The enriching includes merging play-by-play data for the game with the tracking data of the corresponding game. The operations further include generating, by the computing system, padded tracking data based on the tracking data. The operations further include identifying, by the computing system, a subset of players that have at least a threshold percentage chance of being drafted based on the tracking data and the padded tracking data. The operations further include projecting, by the computing system, a range of draft positions for each player of the subset of players based on the tracking data and the padded tracking data.

In some embodiments, a system is disclosed herein. The system includes a processor and a memory. The memory has programming instructions stored thereon, which, when executed by the processor, causes the system to perform operations. The operations include identifying broadcast video for a plurality of games. The broadcast video includes a plurality of video frames. The operations further include generating tracking data for each game from the broadcast video of a corresponding game. The operations further include enriching the tracking data. The enriching includes merging play-by-play data for the game with the tracking data of the corresponding game. The operations further include generating padded tracking data based on the tracking data. The operations further include identifying a subset of players that have at least a threshold percentage chance of being drafted based on the tracking data and the padded tracking data. The operations further include projecting a range of draft positions for each player of the subset of players based on the tracking data and the padded tracking data.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating prediction system of the computing system of FIG. 1, according to example embodiments.

FIG. 3 illustrates an exemplary chart corresponding to the Shapley values generated for Player A using raw data and padded data, according to example embodiments.

FIG. 4 illustrates an exemplary chart corresponding to a draft talent bin prediction for Player B, according to example embodiments.

FIG. 5A is a flow diagram illustrating a method of predicting a range of draft positions for a draft eligible player, according to example embodiments.

FIG. 5B is a flow diagram illustrating a method of predicting player performance in a second league for a player from a first league, according to example embodiments.

FIG. 6A is a block diagram illustrating a computing device, according to example embodiments.

FIG. 6B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The field of sports analytics has grown exponentially over the years as access to finer grained player data in the world of professional sports in the United States has become easier. However, while professional sports leagues have the revenue to install state of the art optical player and ball tracking systems in select arenas and/or stadiums, such wide-spread adoption is not present in non-professional sports leagues. For example, for basketball, select NBA arenas may have an optical player and ball tracking system deployed therein; however, colleges and universities in the NCAA, teams in the NBA development league (i.e., the G-league), and international leagues (e.g., Liga ACB in Spain, Chinese Basketball Association, Basketball Champions League, and the like) may not have the revenue or ability to deploy optical player and ball tracking systems in the arenas those teams occupy. For example, in-venue hardware solutions are simply impractical for the NCAA, with over 300 Division I schools alone in addition to the numerous exhibition, tournament, and post-season games not played at NCAA venues. Such limitation impacts the NBA, for example, in that NBA teams are thus severely limited in their decision making ability for an upcoming track due to the lack of detailed tracking data of draft-eligible players from these leagues. Additionally, this limitation is compounded by the fact that in-venue optical player and ball tracking systems are a newer phenomenon. As such, it is difficult for an NBA front office to accurately model a college player's future potential output, as there is a lack of historical tracking data for current or past NBA players to build a training set for modeling.

To account for this limitation, one or more techniques described herein utilize state-of-the-art computer vision techniques to capture player and ball tracking data from thousands of historical non-NBA games (e.g., NCAA D-I Men's basketball games) directly from broadcast video. The volume of such data may equate to more than 650,000 possessions and over 300 million frames of broadcast video. From the tracking data, the one or more techniques described herein automatically detect events, such as, but not limited to, ball-screens, drives, isolations, post-ups, off-ball screens, defensive match-ups, etc., using an actor-action attention neural network system.

While the one or more techniques for generating tracking data from broadcast video data for non-professional sports (e.g., college basketball) is in itself a massive breakthrough in the field of sports analytics, the tracking data alone is not enough for the present task. To showcase the value of the generated tracking data, the present technique implements a trained prediction model configured to predict the talent of future NBA players based, in part, on the generated tracking data. For example, the prediction model described herein is configured to predict the probability of a player making the NBA directly from the non-professional data. Through the use of the generated tracking data, the present techniques are able to obtain or generate more accurate forecasts of draft-eligible player performance in the NBA compared to traditional or conventional data source.

Additionally, while projecting or predicting the talent of future NBA players is a substantial contribution to the technical field of sports analytics in and of itself, the present approach may not be limited to a single output. Instead, one or more techniques described herein utilizes interpretable machine learning techniques, such as Shapley values, to not only create accurate predictions, but also identify the strengths and weaknesses of a specific player.

While the present techniques described herein are described in conjunction with the NBA and projecting college athlete performance in the NBA, those skilled in the art understand that such techniques can be applied beyond college athlete performance and to international player performance. Additionally, the present solution is not intended to be limited to projecting performance in the NBA. Instead, the one or more techniques described herein can be broadly applied to project player performance from League X to League Y in any sport.

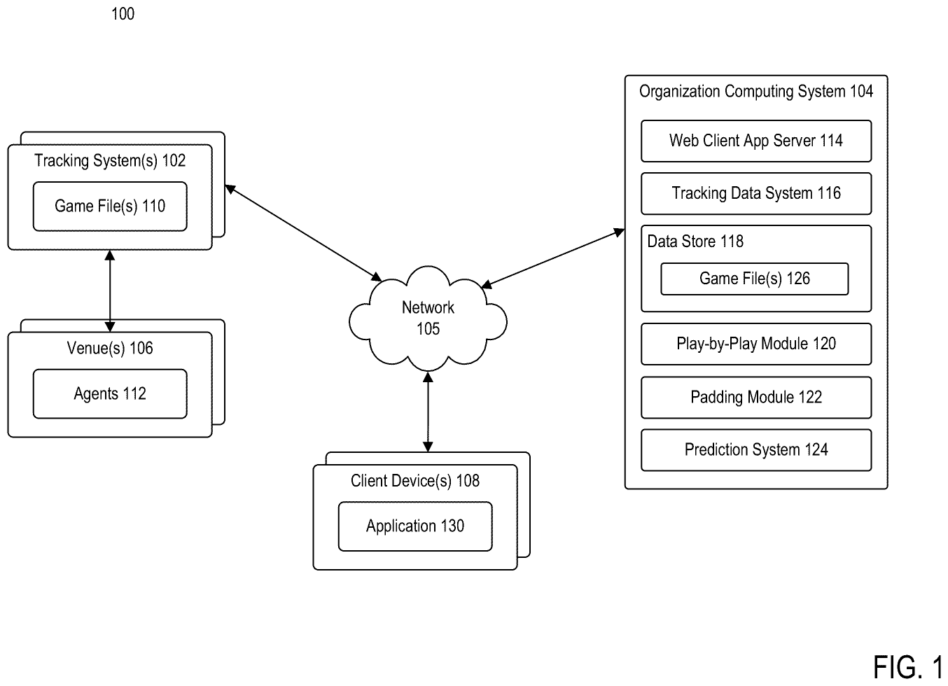

FIG. 1 is a block diagram illustrating a computing environment 100, according to example embodiments. Computing environment 100 may include tracking system 102, organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to capture the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In another example, a mix of stationary and non-stationary cameras may be used to capture motions of all agents on the playing surface as well as one or more objects or relevance. As those skilled in the art recognize, utilization of such tracking system (e.g., tracking system 102) may result in many different camera views of the court (e.g., high sideline view, free-throw line view, huddle view, face-off view, end zone view, etc.).

In some embodiments, tracking system 102 may be used for a broadcast feed of a given match. In such embodiments, each frame of the broadcast feed may be stored in a game file 110.

In some embodiments, game file 110 may further be augmented with other event information corresponding to event data, such as, but not limited to, game event information (pass, made shot, turnover, etc.) and context information (current score, time remaining, etc.).

Tracking system 102 may be configured to communicate with organization computing system 104 via network 105. For example, tracking system 102 may be configured to provide organization computing system 104 with a broadcast stream of a game or event in real-time or near real-time via network 105.

Organization computing system 104 may be configured to process the broadcast stream of the game. Organization computing system 104 may include at least a web client application server 114, tracking data system 116, data store 118, play-by-play module 120, padding module 122, and prediction system 124. Each of tracking data system 116, play-by-play module 120, padding module 122, and prediction system 124 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. In some embodiments, tracking data system 116 may largely be representative of AutoSTATS®, an artificial intelligence and computer vision system configured to derive player-tracking data from broadcast video feeds, commercially available from STATS Perform, headquartered in Chicago, Illinois.

To generate the tracking data from the broadcast data, tracking data system 116 may map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may reidentify players who are not within a line of sight of a camera during a given frame. In some embodiments, tracking data system 116 may further detect and track the ball across all frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast. For example, tracking data system 116 may perform such processes to generate tracking data across 650,000 college basketball possessions, totaling about 300 million broadcast frames. In addition to such process, organization computing system 104 may go beyond the generation of tracking data from broadcast video data. Instead, to provide descriptive analytics, as well as a useful feature representation for prediction system 124, organization computing system 104 may be configured to map the tracking data to a semantic layer (i.e., events).

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize manually annotated data that may reflect the referee's ultimate adjudication. Such data may be referred to as the play-by-play feed.

To help identify events within the generated tracking data, tracking data system 116 may merge or align the play-by-play data with the raw generated tracking data (which may include the game and shot clock). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, rebounds, passes, dribbles and possessions. Tracking data system 116 may further include a host of specialist event detectors trained to identify higher-level events. Exemplary higher-level events may include, but are not limited to, postups, drives, isolations, ball-screens, handoffs, off-ball-screens, the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame), as well as other defensive information such as coverages for ball-screens.

In some embodiments, to measure defense, tracking data system 116 may use a measure referred to as an “influence score.” The influences score may capture the influence a defender may have on each offensive player on a scale of 0-100. In some embodiments, the value for the influence score may be based on basketball defensive principles, such as, but not limited to, proximity to player, distance from basket, passing lanes, lanes to the basket, and the like.

In some embodiments, in addition to assigning frame-level defensive matchups using the influences score, tracking data system 116 may further use the influence score to assign defender roles for the ball-handler and screener for on-ball screens. In some embodiments, tracking data system 116 may further use the influence score to assign defender roles for the cutter and screener for off-ball screens.

Padding module 122 may be configured to create new player representations using mean-regression to reduce random noise in the features. For example, one of the profound challenges of modeling using potentially only 20-30 games of NCAA data per player may be the high variance of low frequency events seen in the tracking data. A highly talented one and done player may, for example, only attempt 50 isolation shots in a career. Such limited amount of data may not be enough to generate a robust mean value for the player's isolation shooting percentage. Therefore, padding module 122 may be configured to utilize a padding method, which may be a weighted average between the observed values and sample mean. Padding module 122 may solve for the optimal weighting constant, C, which may best predict the next game of a player's career. Because this approach can be applied to any game level statistic, padding module 122 may be configured to apply such technique to every feature in both box-score and AutoSTATS data. In some embodiments, certain player level statistics, such as height, weight, minutes/possessions played, etc. may be excluded.

Accordingly, for each player, tracking data system 116, play-by-play module 120, and padding module 122 may work in conjunction to generate a raw data set and a padded data set for each player.

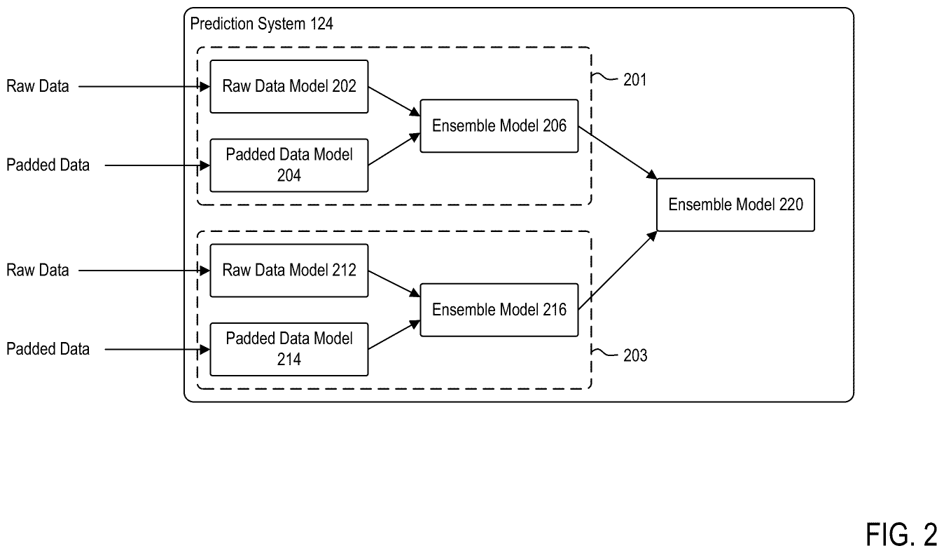

Prediction system 124 may be configured or trained to generate or identify the likelihood of a draft-eligible player to be drafted. Prediction system 124 is discussed further in conjunction with FIG. 2 provided below.

Data store 118 may be configured to store one or more game files 126. Each game file 126 may include video data of a given match. For example, the video data may correspond to a plurality of video frames captured by tracking system 102, the tracking data derived from the broadcast video as generated by tracking data system 116, play-by-play data, enriched data, and/or padded training data.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104. For example, client device 108 may be configured to execute application 130 to view NBA draft projections of draft eligible players. The content that is displayed to client device 108 may be transmitted from web client application server 114 to client device 108, and subsequently processed by application 130 for display through a graphical user interface (GUI) of client device 108.

FIG. 2 is a block diagram illustrating prediction system 124, according to example embodiments. As shown, prediction system 124 may include several models. For example, prediction system 124 may include a first set of models 201 and a second set of models 203. First set of models 201 may be configured to generate a prediction related to whether a player will make the NBA. Second set of models 204 may be configured to generate a prediction related to the player's projected draft pick. An ensemble model 220 may be used to classify the player into one of several bins, with each bin representing a range of draft picks.

As shown, first set of models 204 may include a raw data model 202, a padded data model 204, and an ensemble model 206. Each of raw data model 202, padded data model 204, and ensemble model 206 may be referred to as classification models. For example, instead of using only the padded data, prediction system 124 may include two models—raw data model 202 using the raw data and padded data model 204 using padded data—and then ensembling the results using ensemble model 206. In some embodiments, for each of the raw data set and the padded data set, each data set may be prepared similarly for processing. For example, with the high dimensionality and relative similarity between many of the features, pairs of features that may be high collinear may be halved, starting with the most highly correlated. Whichever of each pair was more correlated with remaining features may be removed until no two features had an R² above a certain threshold (e.g., =>0.95).

In some embodiments, raw data model 202 for the raw data may be representative of a LightGBM classifier. In some embodiments, padded data model 204 for the padded data may be representative of a LightGBM classifier. In some embodiments, the hyperparameters for each of raw data model 202 and padded data model 204 may be tuned using five-fold cross validation on a random search across a parameter grid. By using a classifier, each model's predictions may be representative of a probability of the player making the NBA.

In some embodiments, the ensembling of both outputs from raw data model 202 and padded data model 204 may work to include predictive information contained separately in both data sets. The features space for the ensemble, a random forest classifier, may be the raw prediction, the padded prediction, and chances per game, an AutoSTATS derived feature that may be analogous to possessions per game.

In some embodiments, in order to properly understand why raw data model 202 and padded data model 204 made their predictions, prediction system 124 may utilize Shapley values, which is a game theory approach to interpret results of machine learning models. The Shapley values may provide, on a per-prediction basis, the direction and magnitude of each feature's contribution to the overall prediction. By combining the Shapley values for each of raw data model 202 and padded data model 204, the result may be used to understand the interplay between the raw data and the padded data, and the differing information they may provide.

While the outputs generated by each of raw data model 202 and padded data model 204 may be useful for understanding how the models function, the outputs may be used to trim the overall dataset of players to those plausible NBA players and begin the actual draft modeling. For example, raw data model 202 and padded data model 204 may be used to identify those players with greater than an x % (e.g., 40%) chance to make the NBA.

Second set of models 203 may be used in conjunction with first set of models 201 for projecting a range of draft picks in which a player may fall. As shown, the overall architecture of prediction system 124 may include first set of models 201 (described above), raw data model 212, padded data model 214, and ensemble model 216. As shown, the new components for the talent bin ensemble model may reuse the framework, where both the decorrelated raw and decorrelated padded data may be used in separate models and then ensembled to create three sets of predictions that may be carried forward. In some embodiments, each of raw data model 212 and padded data model 214 may be random forest regressors using a VORP (value over replacement player) pick values at each draft pick target. The predictions from raw data model 212 and padded data model 214 may then ensembled, with additional information from the make NBA models using NGBoost (e.g., ensemble model 216) to create regression predictions with independently modeled means and variances. The outputs from all existing and new components may be ensembled using a random forest multiclass classifier (e.g., ensemble model 220). For example, output from ensemble model 220 may classify a player into one of several bins. Exemplary bins may include:

| Bin | Pick Ranges |
|---|---|
| 1 | 1-2 |
| 2 | 3-5 |
| 3 | 6-8 |
| 4 | 9-12 |
| 5 | 13-17 |
| 6 | 18-26 |
| 7 | 27-39 |
| 8 | 40-50 |
| 9 | 41-61 |

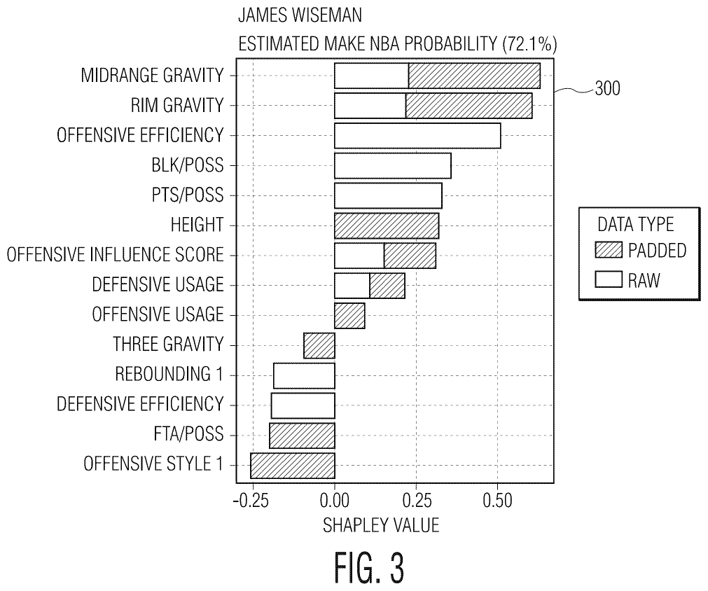

FIG. 3 illustrates an exemplary chart 300 corresponding to the Shapley values generated for Player A using raw data and padded data, according to example embodiments.

As shown, Player A may correspond to James Wiseman, who was drafted #2 overall by the Golden State Warriors in the 2021 NBA Draft. Wiseman is a particularly interesting case because he only played a total of three games (69 minutes) in his college career. Looking at the raw data model, features such as points per possession (PTS/Poss) and blocks per possession (BLK/Poss) show very strongly as positive indicators of making the NBA. However, without their regressed versions (shown with dashed fill), which would show up as a stacked bar. Unsurprisingly, the padded data has regressed a three-game sample very heavily and reduced the quality of his raw scoring and block output. Non-regressed features, such as Rim Gravity and Midrange Gravity (both metrics of spatially weighted offensive efficiency and usage) show strongly positive in both the raw and padded data sets. Wiseman is a good example of not blindly adhering to model output. The model does not know why he only played three games, but when the padded and strongly regressed data are ensembled, the prediction is a lower probability of making the NBA compared to what would be expected based on known contextual information about his career.

It is important to note that the values are not outputs from the final ensemble, but are instead the outputs of the two primary sub-models of the ensemble, i.e., the raw data model and the padded data model.

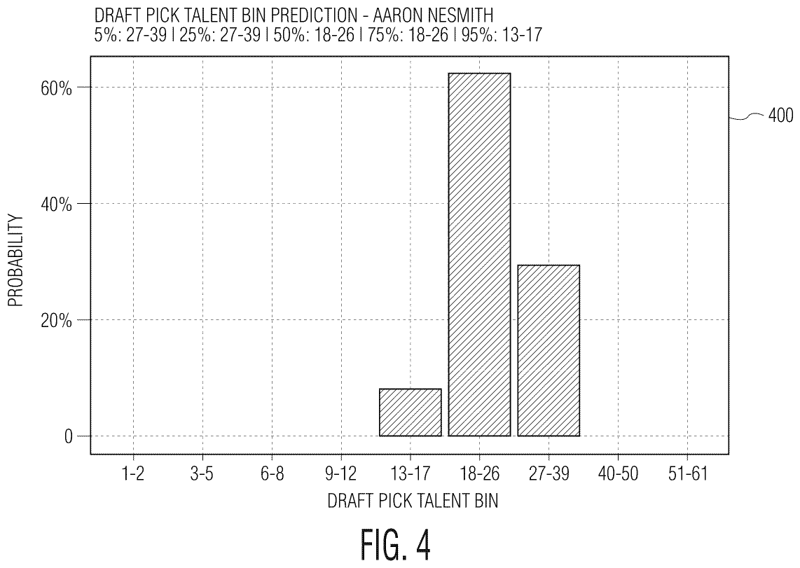

FIG. 4 illustrates an exemplary chart 400 corresponding to a draft talent bin prediction for Player B, according to example embodiments.

As shown, Player B may correspond to Aaron Nesmith. Prediction system 124 may provide that Nesmith has approximately a 62% chance of having the statistical profile of a player picked in the 18-26 range historically. As this does not include any NBA or pre-draft rankings, the output from prediction system 124 is not predicting where a player will be taken, only what range of player to which they are similar.

While prediction system 124 does not actually attempt to answer the question of how good Player B will be, there is some semblance of a quality gradient under the assumption that early picks are usually better NBA players than later picks.

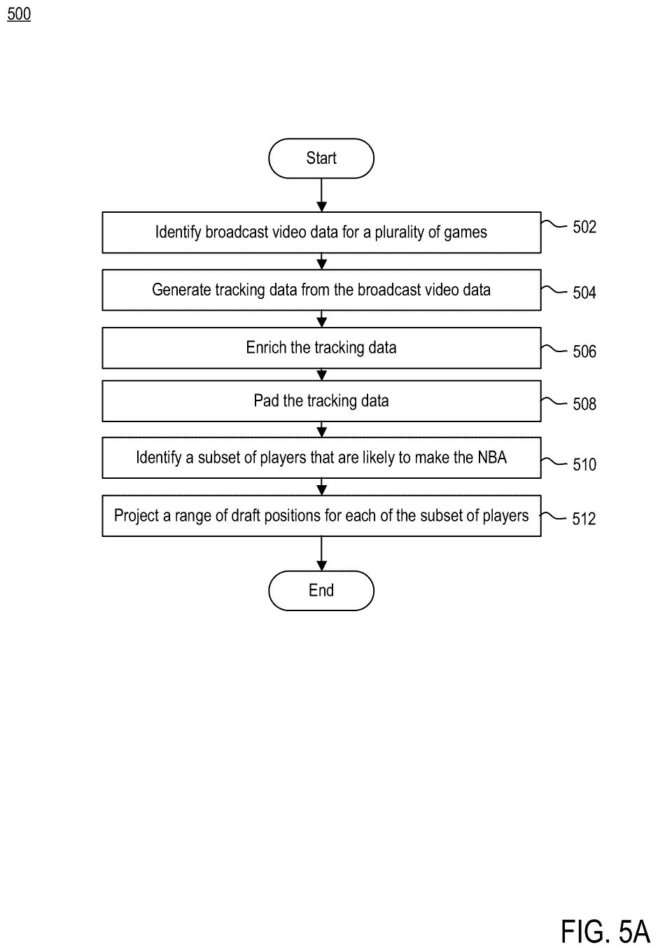

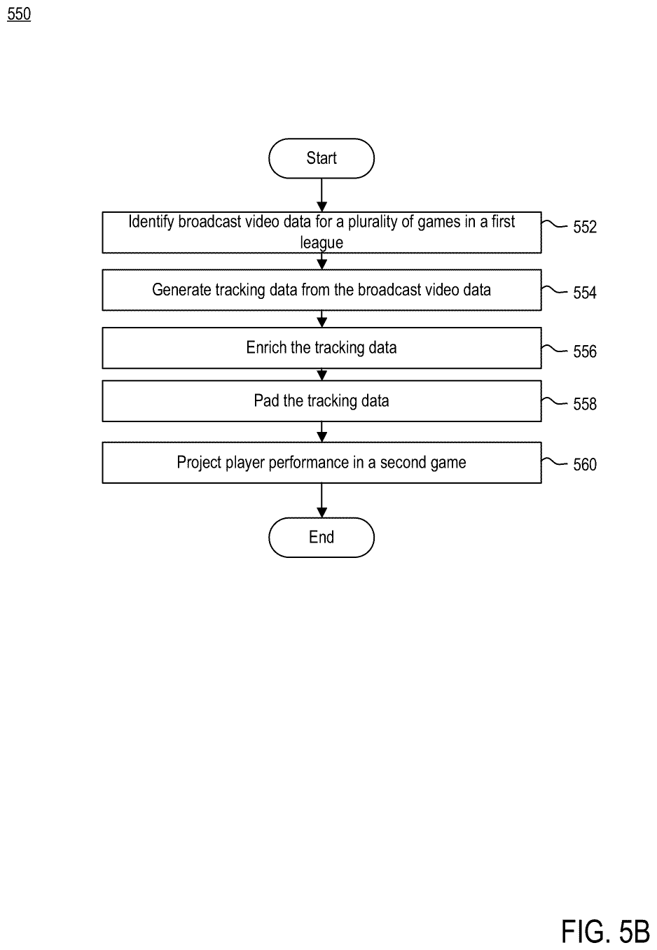

FIG. 5A is a flow diagram illustrating a method 500 of predicting a range of draft positions for a draft eligible player, according to example embodiments. Method 500 may begin at step 502.

At step 502, organization computing system 104 may identify broadcast video data for a plurality of games. In some embodiments, the broadcast video data may be received from tracking system 102. In some embodiments, the broadcast video data for a game may be stored in data store 118. For example, the broadcast video data may be stored in a game file 126 corresponding to a game or event. Generally, the broadcast video data may include a plurality of video frames. In some embodiments, one or more video frames of the broadcast video data may include data, such as score board data included therein.

At step 504, organization computing system 104 may generate tracking data from the broadcast video data. For example, for each game, tracking data system 116 may use one or more computer vision and/or machine learning techniques to generate tracking data from the broadcast video data. To generate the tracking data from the broadcast data, tracking data system 116 may map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may re-identify players who are not within a line of sight of a camera during a given frame. In some embodiments, tracking data system 116 may further detect and track the ball across all frames. In some embodiments, tracking data system 116 may further utilize optical character recognition techniques. For example, tracking data system 116 may utilize optical character recognition techniques to extract score information and time remaining information from a digital scoreboard of each frame.

At step 506, organization computing system 104 may enrich the tracking data. In some embodiments, enriching the tracking data may include tracking data system 116 merging play-by-play data for an event with the generated tracking data. For example, play-by-play module 120 may receive a play-by-play feed corresponding to the broadcast video data. In some embodiments, the play-by-play data may be representative of human generated data based on events occurring within the game. Tracking data system 116 may merge or align the play-by-play data with the raw generated tracking data (which may include the game and shot clock). In some embodiments, tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

In some embodiments, enriching the tracking data may include tracking data system 116 performing various operations on the aligned tracking system. For example, tracking data system 116 may use the play-by-play data to refine the player and ball positions and precise frame of the end of possession events (e.g., shot/rebound location).

In some embodiments, enriching the tracking data may include tracking data system 116 detecting events, automatically, from the tracking data. For example, tracking data system 116 may include a neural network system trained to detect/refine various events in a sequential manner. For example, tracking data system 116 may include an actor-action attention neural network system to detect/refine one or more of: shots, rebounds, passes, dribbles and possessions. Tracking data system 116 may further include a host of specialist event detectors trained to identify higher-level events. Exemplary higher-level events may include, but are not limited to, postups, drives, isolations, ball-screens, handoffs, off-ball-screens, the like. In some embodiments, each of the specialist event detectors may be representative of a neural network, specially trained to identify a specific event type.

In some embodiments, enriching the tracking data may include tracking data system 116 enhancing the detected events with contextual information. For example, tracking data system 116 may generate contextual information to enhance the detected events. Exemplary contextual information may include defensive matchup information (e.g., who is guarding who at each frame), as well as other defensive information such as coverages for ball-screens.

In some embodiments, enriching the tracking data may include tracking data system 116 generating an “influence score” for each matchup. The influences score may capture the influence a defender may have on each offensive player on a scale of 0-100. In some embodiments, the value for the influence score may be based on basketball defensive principles, such as, but not limited to, proximity to player, distance from basket, passing lanes, lanes to the basket, and the like.

In some embodiments, enriching the tracking data may include tracking data system 116 using the influence score to assign defender roles for the ball-handler and screener for on-ball screens. In some embodiments, tracking data system 116 may further use the influence score to assign defender roles for the cutter and screener for off-ball screens.

At step 508, organization computing system 104 may pad the tracking data. For example, padding module 122 may create new player representations using mean-regression to reduce random noise in the features. For example, one of the profound challenges of modeling using potentially only 20-30 games of NCAA data per player may be the high variance of low frequency events seen in the tracking data. A highly talented one and done player may, for example, only attempt 50 isolation shots in a career. Such limited amount of data may not be enough to generate a robust mean value for the player's isolation shooting percentage. Therefore, padding module 122 may be configured to utilize a padding method, which may be a weighted average between the observed values and sample mean. Padding module 122 may solve for the optimal weighting constant, C, which may best predict the next game of a player's career. Because this approach can be applied to any game level statistic, padding module 122 may be configured to apply such technique to every feature in both box-score and AutoSTATS data. In some embodiments, certain player level statistics, such as height, weight, minutes/possessions played, etc. may be excluded.

At step 510, organization computing system 104 may identify a subset of players that are likely to make the NBA. In some embodiments, prediction system 124 may identify the subset of players based on the raw tracking data and the padded tracking data. In some embodiments, each player of the subset of players may have better than a threshold percentage chance (e.g., 40%) of making the NBA.

At step 512, organization computing system 104 may project a range of draft positions for each player of the subset of players. For example, prediction system 124 may classify each player in the subset of players into one of several bins. Each bin may represent a range of draft positions. In this manner, prediction system 124 may identify the chances of each player having a statistical profile of a player picked in various ranges.

FIG. 5B is a flow diagram illustrating a method 550 of predicting player performance in a second league for a player from a first league, according to example embodiments. Method 550 may begin at step 552.

At step 552, organization computing system 104 may identify broadcast video data for a plurality of games in a first league. In some embodiments, the first league may be representative of a league or conference. For example, the first league may be NCAA men's basketball, Big 10 men's basketball, NBA Eastern Conference, NBA Atlantic Division, NBA G-league, international leagues, and the like. In some embodiments, the broadcast video data may be received from tracking system 102. In some embodiments, the broadcast video data for a game may be stored in data store 118. For example, the broadcast video data may be stored in a game file 126 corresponding to a game or event. Generally, the broadcast video data may include a plurality of video frames. In some embodiments, one or more video frames of the broadcast video data may include data, such as score board data included therein.

At step 554, organization computing system 104 may generate tracking data from the broadcast video data. For example, for each game, tracking data system 116 may use one or more computer vision and/or machine learning techniques to generate tracking data from the broadcast video data. To generate the tracking data from the broadcast data, tracking data system 116 may map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may re-identify players who are not within a line of sight of a camera during a given frame. In some embodiments, tracking data system 116 may further detect and track the ball across all frames. In some embodiments, tracking data system 116 may further utilize optical character recognition techniques. For example, tracking data system 116 may utilize optical character recognition techniques to extract score information and time remaining information from a digital scoreboard of each frame.

At step 556, organization computing system 104 may enrich the tracking data. In some embodiments, enriching the tracking data may include tracking data system 116 merging play-by-play data for an event with the generated tracking data. For example, play-by-play module 120 may receive a play-by-play feed corresponding to the broadcast video data. In some embodiments, the play-by-play data may be representative of human generated data based on events occurring within the game. Tracking data system 116 may merge or align the play-by-play data with the raw generated tracking data (which may include the game and shot clock). In some embodiments, tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

In some embodiments, enriching the tracking data may include tracking data system 116 performing various operations on the aligned tracking system. For example, tracking data system 116 may use the play-by-play data to refine the player and ball positions and precise frame of the end of possession events (e.g., shot/rebound location).

In some embodiments, enriching the tracking data may include tracking data system 116 detecting events, automatically, from the tracking data. For example, tracking data system 116 may include a neural network system trained to detect/refine various events in a sequential manner. For example, tracking data system 116 may include an actor-action attention neural network system to detect/refine one or more of: shots, rebounds, passes, dribbles and possessions. Tracking data system 116 may further include a host of specialist event detectors trained to identify higher-level events. Exemplary higher-level events may include, but are not limited to, postups, drives, isolations, ball-screens, handoffs, off-ball-screens, the like. In some embodiments, each of the specialist event detectors may be representative of a neural network, specially trained to identify a specific event type.

In some embodiments, enriching the tracking data may include tracking data system 116 enhancing the detected events with contextual information. For example, tracking data system 116 may generate contextual information to enhance the detected events. Exemplary contextual information may include defensive matchup information (e.g., who is guarding who at each frame), as well as other defensive information such as coverages for ball-screens.

In some embodiments, enriching the tracking data may include tracking data system 116 generating an “influence score” for each matchup. The influences score may capture the influence a defender may have on each offensive player on a scale of 0-100. In some embodiments, the value for the influence score may be based on basketball defensive principles, such as, but not limited to, proximity to player, distance from basket, passing lanes, lanes to the basket, and the like.

In some embodiments, enriching the tracking data may include tracking data system 116 using the influence score to assign defender roles for the ball-handler and screener for on-ball screens. In some embodiments, tracking data system 116 may further use the influence score to assign defender roles for the cutter and screener for off-ball screens.

At step 558, organization computing system 104 may pad the tracking data. For example, padding module 122 may create new player representations using mean-regression to reduce random noise in the features. In some embodiments, padding module 122 may be configured to utilize a padding method, which may be a weighted average between the observed values and sample mean. Padding module 122 may solve for the optimal weighting constant, C, which may best predict the next game of a player's career. Because this approach can be applied to any game level statistic, padding module 122 may be configured to apply such technique to every feature in both box-score and AutoSTATS data. In some embodiments, certain player level statistics, such as height, weight, minutes/possessions played, etc. may be excluded.

At step 560, organization computing system 104 may generate player performance projections in a second league for each player. In some embodiments, the second league may be a target league for which a player may be traded, signed to, etc. Using a specific example, the first league could be NBA Eastern Conference and the second league could be NBA Western Conference. In another example, the first league could be G-league and the second league could be the Chinese Basketball Association. In some embodiments, prediction system 124 may project player performance in the second league by classifying each player into one of several bins. Each bin may represent a tier of player performance (e.g., bin 1=bench player; bin 2=rotation player; bin 3=starter; bin 4=superstar; and the like. In some embodiments, prediction system 124 may project player performance by projecting or estimating season averages for each player in the new league.

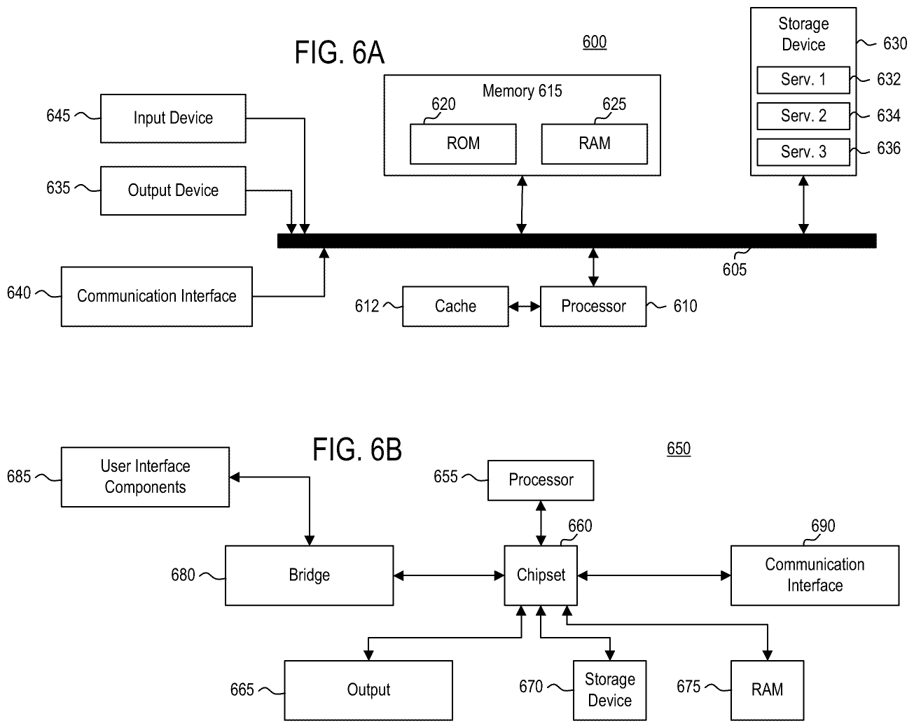

FIG. 6A illustrates an architecture of computing system 600, according to example embodiments. System 600 may be representative of at least a portion of organization computing system 104. One or more components of system 600 may be in electrical communication with each other using a bus 605. System 600 may include a processing unit (CPU or processor) 610 and a system bus 605 that couples various system components including the system memory 615, such as read only memory (ROM) 620 and random access memory (RAM) 625, to processor 610. System 600 may include a cache of high-speed memory connected directly with, in close proximity to, or integrated as part of processor 610. System 600 may copy data from memory 615 and/or storage device 630 to cache 612 for quick access by processor 610. In this way, cache 612 may provide a performance boost that avoids processor 610 delays while waiting for data. These and other modules may control or be configured to control processor 610 to perform various actions. Other system memory 615 may be available for use as well. Memory 615 may include multiple different types of memory with different performance characteristics. Processor 610 may include any general purpose processor and a hardware module or software module, such as service 1 632, service 2 634, and service 3 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction with the computing system 600, an input device 645 may represent any number of input mechanisms, such as a microphone for speech, a touch-sensitive screen for gesture or graphical input, keyboard, mouse, motion input, speech and so forth. An output device 635 (e.g., display) may also be one or more of a number of output mechanisms known to those of skill in the art. In some instances, multimodal systems may enable a user to provide multiple types of input to communicate with computing system 600. Communications interface 640 may generally govern and manage the user input and system output. There is no restriction on operating on any particular hardware arrangement and therefore the basic features here may easily be substituted for improved hardware or firmware arrangements as they are developed.

Storage device 630 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 625, read only memory (ROM) 620, and hybrids thereof.

Storage device 630 may include services 632, 634, and 636 for controlling the processor 610. Other hardware or software modules are contemplated. Storage device 630 may be connected to system bus 605. In one aspect, a hardware module that performs a particular function may include the software component stored in a computer-readable medium in connection with the necessary hardware components, such as processor 610, bus 605, output device 635, and so forth, to carry out the function.

FIG. 6B illustrates a computer system 650 having a chipset architecture that may represent at least a portion of organization computing system 104. Computer system 650 may be an example of computer hardware, software, and firmware that may be used to implement the disclosed technology. System 650 may include a processor 655, representative of any number of physically and/or logically distinct resources capable of executing software, firmware, and hardware configured to perform identified computations. Processor 655 may communicate with a chipset 660 that may control input to and output from processor 655. In this example, chipset 660 outputs information to output 665, such as a display, and may read and write information to storage device 670, which may include magnetic media, and solid-state media, for example. Chipset 660 may also read data from and write data to RAM 675. A bridge 680 for interfacing with a variety of user interface components 685 may be provided for interfacing with chipset 660. Such user interface components 685 may include a keyboard, a microphone, touch detection and processing circuitry, a pointing device, such as a mouse, and so on. In general, inputs to system 650 may come from any of a variety of sources, machine generated and/or human generated.

Chipset 660 may also interface with one or more communication interfaces 690 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 655 analyzing data stored in storage device 670 or RAM 675. Further, the machine may receive inputs from a user through user interface components 685 and execute appropriate functions, such as browsing functions by interpreting these inputs using processor 655.

It may be appreciated that example systems 600 and 650 may have more than one processor 610 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A computer-implemented method for predicting one or more draft positions for a player, the computer-implemented method comprising:
generating, by one or more processors, tracking data corresponding to broadcast video data of a corresponding game, wherein the tracking data includes one or more players;
padding, by the one or more processors, the tracking data to create one or more new player representations corresponding to the one or more players;
identifying, by the one or more processors, a subset of players based on the tracking data and the padded tracking data; and
projecting, by the one or more processors, a plurality of draft positions for each player of the subset of players.

2. The computer-implemented method of claim 1, the computer-implemented method further comprising:
enriching, by the one or more processors, the tracking data by merging play-by-play data with the tracking data.

3. The computer-implemented method of claim 2, the computer-implemented method further comprising:
refining, by the one or more processors, one or more positions corresponding to the one or more players based on the enriched tracking data.

4. The computer-implemented method of claim 2, the enriching the tracking data by merging the play-by-play data with the tracking data further comprising:
detecting, by the one or more processors, one or more events corresponding to the tracking data;
determining, by the one or more processors, at least one event type corresponding to the one or more events; and
enhancing, by the one or more processors, the one or more events based on corresponding contextual data.

5. The computer-implemented method of claim 1, the computer-implemented method further comprising:
receiving, by the one or more processors, the broadcast video data for a plurality of games from a tracking system.

6. The computer-implemented method of claim 1, wherein the projecting the plurality of draft positions for each player of the subset of players includes:
classifying, by the one or more processors, each player of the subset of players into a range of draft positions.

7. The computer-implemented method of claim 6, the computer-implemented method comprising:
identifying, by the one or more processors, at least one player chance of each player having a statistical profile corresponding to a position in the range of draft positions.

8. A computer system for predicting one or more draft positions for a player, the computer system comprising:
at least one memory storing instructions; and
at least one processor configured to execute the instructions to perform operations comprising:
generating, by the at least one processor, tracking data corresponding to broadcast video data of a corresponding game, wherein the tracking data includes one or more players;
padding, by the at least one processor, the tracking data to create one or more new player representations corresponding to the one or more players;
identifying, by the at least one processor, a subset of players based on the tracking data and the padded tracking data; and
projecting, by the at least one processor, a plurality of draft positions for each player of the subset of players.

9. The computer system of claim 8, the operations further comprising:
enriching, by the at least one processor, the tracking data by merging play-by-play data with the tracking data.

10. The computer system of claim 9, the operations further comprising:
refining, by the at least one processor, one or more positions corresponding to the one or more players based on the enriched tracking data.

11. The computer system of claim 9, the enriching the tracking data by merging the play-by-play data with the tracking data further comprising:
detecting, by the at least one processor, one or more events corresponding to the tracking data;
determining, by the at least one processor, at least one event type corresponding to the one or more events; and
enhancing, by the at least one processor, the one or more events based on corresponding contextual data.

12. The computer system of claim 8, the operations further comprising:
receiving, by the at least one processor, the broadcast video data for a plurality of games from a tracking system.

13. The computer system of claim 8, wherein the projecting the plurality of draft positions for each player of the subset of players includes:
classifying, by the at least one processor, each player of the subset of players into a range of draft positions.

14. The computer system of claim 13, the operations comprising:
identifying, by the at least one processor, at least one player chance of each player having a statistical profile corresponding to a position in the range of draft positions.

15. A non-transitory computer-readable medium containing instructions that, when executed by a processor, cause the processor to perform operations for predicting one or more draft positions for a player, the operations comprising:
generating tracking data corresponding to broadcast video data of a corresponding game, wherein the tracking data includes one or more players;
padding the tracking data to create one or more new player representations corresponding to the one or more players;
identifying a subset of players based on the tracking data and the padded tracking data; and
projecting a plurality of draft positions for each player of the subset of players.

16. The non-transitory computer-readable medium of claim 15, the operations further comprising:
enriching the tracking data by merging play-by-play data with the tracking data.

17. The non-transitory computer-readable medium of claim 16, the operations further comprising:
refining one or more positions corresponding to the one or more players based on the enriched tracking data.

18. The non-transitory computer-readable medium of claim 16, the enriching the tracking data by merging the play-by-play data with the tracking data further comprising:
detecting one or more events corresponding to the tracking data;
determining at least one event type corresponding to the one or more events; and
enhancing the one or more events based on corresponding contextual data.

19. The non-transitory computer-readable medium of claim 15, the operations further comprising:
receiving the broadcast video data for a plurality of games from a tracking system.

20. The non-transitory computer-readable medium of claim 15, wherein the projecting the plurality of draft positions for each player of the subset of players includes:
classifying each player of the subset of players into a range of draft positions.
